(19) United States
(12) Patent Application Publication
(10) Pub. No.: US 2015/0264874 A1
(43) Pub. Date: Sep. 24, 2015

(54) MISTING DEVICE

(71) Applicant: SIMILGAEA, INC., ROSLYN, NY (US)

(72) Inventor: BENJAMIN ZILKHA, ROSLYN, NY (US)

(73) Assignee: SIMILGAEA, INC., ROSLYN, NY (US)

(21) Appl. No.: 14/220,455

(22) Filed: Mar. 20, 2014

(51) Int. Cl. A01G 31/00; A01G 1/00

(52) U.S. Cl. CPC A01G 31/00; A01G 1/001

(57) ABSTRACT

Technologies are generally described for systems, devices and methods effective to implement misting devices. In various examples, the misting devices may include a nutrient solution in a basin. In some other examples, the misting devices may further include a motor. In still other examples, the misting devices may include a misting apparatus connected to the motor. The misting apparatus may have an external surface at least partially submerged in the nutrient solution. In some examples, the motor and misting apparatus may be arranged such that when the motor spins the misting apparatus the nutrient solution adheres to the external surface. The nutrient solution may be atomized into a mist and the mist may be propelled toward roots of a plant.

### BACKGROUND

Unless otherwise indicated herein, the materials described in this section are not prior art to the claims in this application and are not admitted to be prior art by inclusion in this section.

In an aeroponic system, plants may be grown in air without the use of soil or other media by providing a nutrient mist to the plants. Plants grown using an aeroponic system may benefit from greater exposure of the root system to oxygen, relative to soil based growing systems. Increased aeration of the nutrient solution may allow for more oxygen to reach the roots and may also prevent pathogen formation, leading to higher quality and quantity yields.

### SUMMARY

In some examples, misting devices are generally described. In various examples, the misting devices may include a nutrient solution in a basin. In some other examples, the misting devices may further include a motor. In still other examples, the misting devices may include a misting apparatus connected to the motor. The misting apparatus may have an external surface at least partially submerged in the nutrient solution. In some examples, the motor and misting apparatus may be arranged such that when the motor spins the misting apparatus the nutrient solution adheres to the external surface. The nutrient solution may be atomized into a mist and the mist may be propelled toward roots of a plant.

In some examples, methods for providing a nutrient mist to roots of a plant are generally described. In various examples, the methods may include adhering a nutrient solution to an external surface of a misting apparatus. The external surface may be at least partially submerged in the nutrient solution. In some other examples, the methods may include atomizing the nutrient solution into a mist by spinning of the misting apparatus. In some further examples, the methods may include propelling the mist toward roots of a plant.

In some examples, misting devices are generally described. In various examples the misting devices may include, a nutrient solution in a basin. In some examples the misting devices may further include a motor. In some other examples the misting devices may include an enclosure. In various other examples the misting devices may include a misting apparatus connected to the motor. The misting apparatus may have an external surface at least partially submerged in the nutrient solution. In some examples, the motor and misting apparatus may be arranged such that when the motor spins the misting apparatus the nutrient solution adheres to the external surface, the nutrient solution may atomize into a mist. In some examples, the mist may be propelled toward roots of a plant in the enclosure. In various examples, the enclosure may be effective to contain the mist.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates an example system that can be utilized to implement a misting device;

FIG. 2 illustrates another example misting device including two misting apparatuses;

FIG. 3 depicts yet another example misting device, illustrating an example where the nutrient mist is directed within an enclosure by one or more fans; and

FIG. 4 depicts an example misting system, illustrating an example where the nutrient mist is directed within an enclosure by a spray nozzle;

FIG. 5 depicts a flow diagram for an example process for implementing a misting device;

all arranged according to at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems and devices, related to a misting device.

Briefly stated, technologies are generally described for systems, devices and methods effective to implement misting devices. In various examples, the misting devices may include a nutrient solution in a basin. In some other examples, the misting devices may further include a motor. In still other examples, the misting devices may include a misting apparatus connected to the motor. The misting apparatus may have an external surface at least partially submerged in the nutrient solution. In some examples, the motor and misting apparatus may be arranged such that when the motor spins the misting apparatus the nutrient solution adheres to the external surface. The nutrient solution may be atomized into a mist and the mist may be propelled toward roots of a plant.

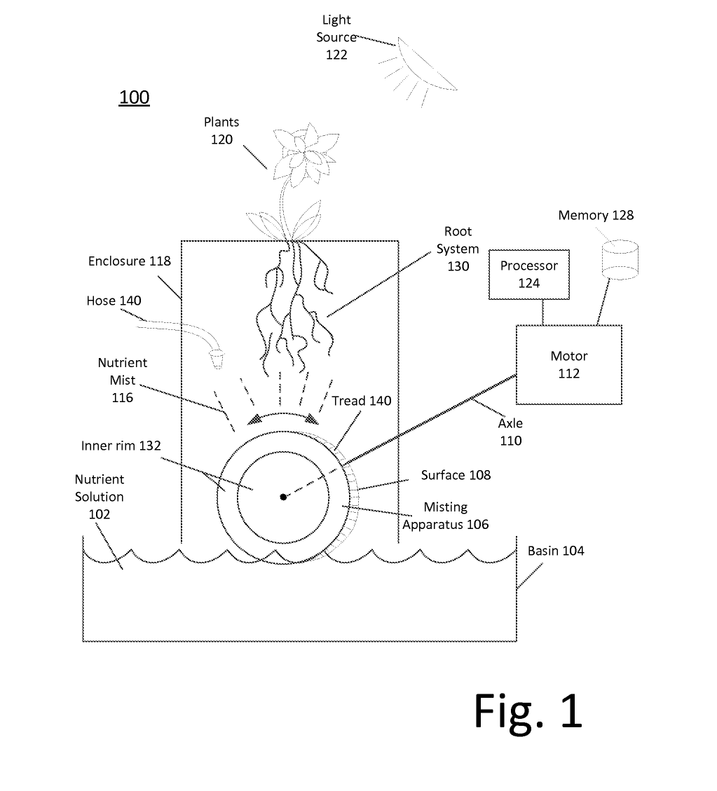

FIG. 1 illustrates an example system 100 that can be utilized to implement a misting device arranged in accordance with at least some embodiments described herein. System 100 may include a basin 104, a nutrient solution 102, a misting apparatus 106, a motor 112, an enclosure 118, and a light source 122. Basin 104 may be a container or other reservoir and may be at least partially filled with nutrient solution 102. Nutrient solution 102 may be a water-based solution including dissolved organic and/or inorganic molecules. Nutrient solution 102 may be adapted to provide nutrition to plants 120 when absorbed by root system 130 of plants 120. Light source 122 may provide light to plants 120 such that photosynthesis may occur. Some examples of light source 122 may include one or more grow lamps and/or the sun.

Misting apparatus 106 may be an object configured to spin around an axis. In some examples, misting apparatus 106 may have a cross-section that is circular, elliptical, oblong, a polygon, and/or another shape. As will be further discussed below, misting apparatus 106 may include paddles, fringes and/or other textured features. Misting apparatus 106 may be at least partially submerged in nutrient solution 102. In some examples, an inner rim 132 of misting apparatus 106 may be made of plastic, rubber, metal, composite fiber and/or other materials. For example, inner rim 132 of misting apparatus 106 may be made from materials which are resistant to rust and/or corrosion. An external surface 108 of misting apparatus 106 may be made of a different material from inner rim 132. In an example, surface 108 may be made from a material to promote adhesion or dispersion of nutrient solution 102. In a further example, surface 108 may be comprised of hydrophilic or hydrophobic material.

Misting apparatus 106 may be spun via the spinning of axle 110. Axle 110 may be connected to and spun around an axis by a motor 112. In some examples, axle 110 may be made of plastic, metal and/or composite fiber. Axle 110 may be resistant to corrosion and/or rust. In some examples, motor 112 may be an electric motor, a combustion motor and/or another type of motor. In an example, motor 112 may be configured in communication with a processor 124 and a memory 128. Processor 124 may execute one or more instructions stored in memory 128. In an example, processor 124 may execute instructions configured to operate motor 112 to spin misting apparatus 106 at a defined speed for a defined duration, beginning at a defined time. For example, processor 124 may execute instructions configured to spin misting apparatus at a speed of X km/hr, beginning at 3:00 PM and ending at 4:00 PM, each day.

Misting apparatus 106 may be spun at a speed sufficient to produce a nutrient mist 116 with a droplet size from about 5-50 μm. For example, misting apparatus 106 may be adapted to spin through nutrient solution 102. In some examples, misting apparatus 106 may be adapted to be at least partially submerged in nutrient solution 102. Misting apparatus 106 may be submerged from the bottom surface of misting apparatus 106 up to axle 110. The level of submersion of misting apparatus 106 may be adjustable. In an example, the degree of submersion of misting apparatus 106 may affect a droplet size of nutrient mist 116. In another example, a hose 140 may be configured to drip, spray, and/or direct nutrient solution 102 onto surface 108 of misting apparatus 106. In an example, nutrient solution 102 may be pumped through hose 140 from basin 104 or from another container.

Because of spinning of motor 112 and features of surface 108, nutrient solution 102 may adhere to surface 108 of misting apparatus 106. Surface 108 may be include a tread. For example, a tread 140 of surface 108 may include features such as one or more channels, grooves, flanges, frayed panels, bumps or other textured features. In some examples, tread 140 may increase the adhesion of nutrient solution 102. In other examples, tread 140 may be adapted to increase an amount of nutrient solution 102 which is propelled away from surface 108. Nutrient solution 102 that has adhered to surface 108 may be propelled away from surface 108 as misting apparatus 106 is spun. Centrifugal force produced by spinning misting apparatus 106 may atomize nutrient solution 102 to produce nutrient mist 116. Nutrient mist 116 may be propelled away from spinning misting apparatus 106 as centrifugal force overcomes adhesive/cohesive forces of the nutrient solution on surface 108. Nutrient mist 116 may be propelled away from misting apparatus 106 as misting apparatus 106 is spun. Nutrient mist 116 may be contained by enclosure 118. Enclosure 118 may be effective to expose root system 130 of plants 120 to nutrient mist 116. Roots of root system 130 may be coated by nutrient mist 116 and may absorb nutrients and water from nutrient mist 116.

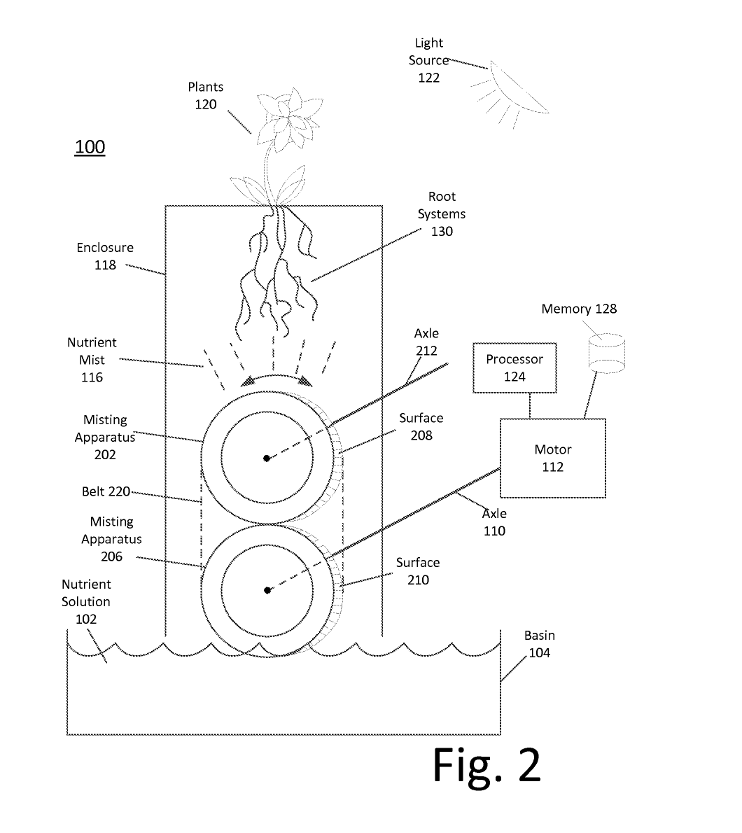

FIG. 2 illustrates another example misting system, including two misting apparatuses, arranged in accordance with at least some embodiments described herein. FIG. 2 includes elements in system 100 of FIG. 1, with additional details. Those components in FIG. 2 that are labeled identically to components of FIG. 1 will not be described again for the purposes of clarity and brevity.

Enclosure 118 may include two misting apparatuses 202 and 206 with respective surfaces 208 and 210. At least one of misting apparatuses 202 and 206 may be at least partially submerged in nutrient solution 102. Misting apparatus 206 may be spun via axle 110. Axle 110 may be spun by motor 112. Friction between surfaces 210 and 208 may cause misting apparatus 202 to spin while motor 112 is spinning misting apparatus 206. Misting apparatuses 202 and 206 may spin along parallel axes. Although depicted in a vertical orientation in FIG. 2, misting apparatuses 202 and 206 may be oriented horizontally or at some angle relative to the bottom of basin 104. Additionally, more than two misting apparatuses may be used to produce nutrient mist 116. In another example, two or more misting apparatuses may be connected by a belt 220 such that nutrient mist 116 is propelled away from a surface of belt 220. Belt 220 may include a tread, such as one or more channels, grooves, flanges, frayed panels, bumps or other textured features.

Misting apparatus 206 may spin through nutrient solution 102. Nutrient solution 102 may adhere to surface 210 of misting apparatus 206. Some of nutrient solution 102 that has adhered to surface 210 may be transferred to surface 208 as misting apparatuses 206 and 202 spin in contact with one another. Nutrient solution 102 that has adhered to surface 208 of misting apparatus 202 may be propelled away from surface 208 via inertia as nutrient mist 116. Nutrient mist 116 may be contained by enclosure 118. Enclosure 118 may be effective to expose root system 130 of plants 120 to nutrient mist 116. Roots of root system 130 may be coated by nutrient mist 116 and may absorb nutrients and water from nutrient mist 116.

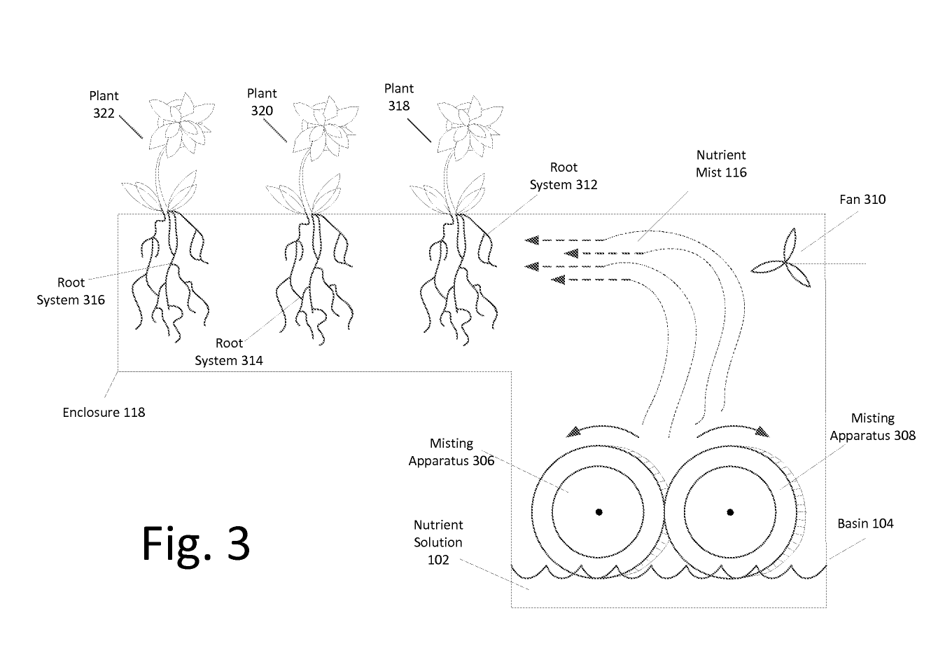

FIG. 3 depicts an example misting system, illustrating an example where the nutrient mist is directed within an enclosure by one or more fans, arranged in accordance with at least some embodiments described herein. FIG. 3 includes elements in system 100 of FIG. 1 and FIG. 2, with additional details. Those components in FIG. 3 that are labeled identically to components of FIG. 1 and FIG. 2 will not be described again for the purposes of clarity.

Misting apparatus 306 and/or 308 may spin through nutrient solution 102 and produce nutrient mist 116. In an example, misting apparatuses 306 and 308 may spin in contact with one another. Misting apparatuses spinning in contact with one another may result in a nutrient mist of smaller droplet size relative to one misting apparatus spinning alone. Nutrient mist 116 may be directed by one or more fans, such as fan 310, within enclosure 118. Fans 310 may be positioned at various points within enclosure 118 such that nutrient mist 116 is provided for root systems 312, 314 and 316 of plants 318, 320 and 322.

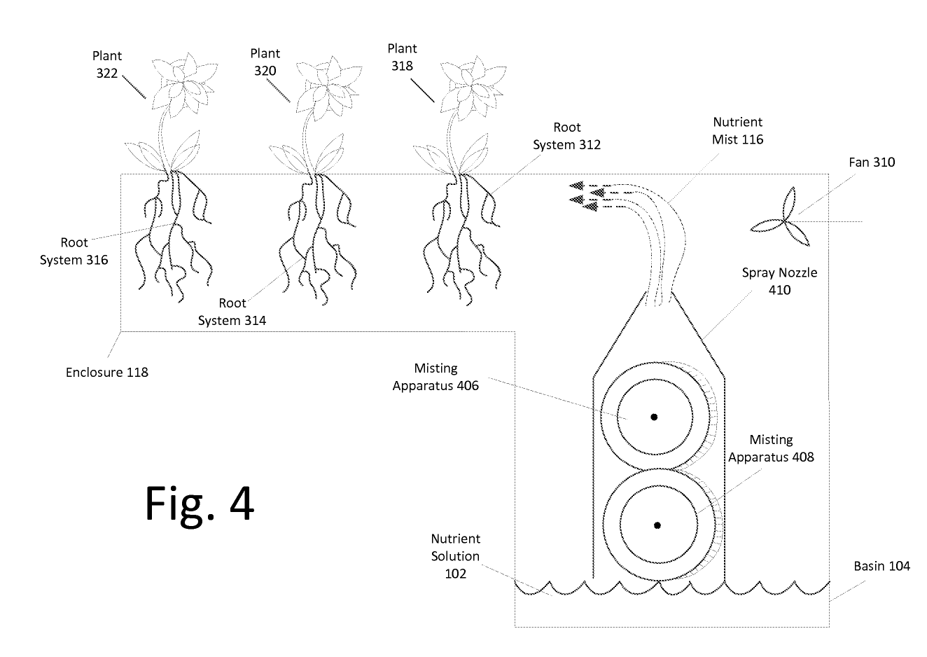

FIG. 4 depicts an example misting system, illustrating an example where the nutrient mist is directed within an enclosure by a spray nozzle, arranged in accordance with at least some embodiments described herein. FIG. 4 includes elements in system 100 of FIGS. 1, 2 and 3, with additional details. Those components in FIG. 4 that are labeled identically to components of FIGS. 1, 2, and 3 will not be described again for the purposes of clarity.

In an example, one or more misting apparatuses (such as misting apparatus 406 and/or misting apparatus 408) may be at least partially enclosed within a spray nozzle 410. Spray nozzle 410 may be made of materials which are resistant to rust and/or corrosion. Spray nozzle 410 may be effective to direct nutrient mist 116 toward root systems of plants, such as roots systems 312, 314, and/or 316 of plants 318, 320, and/or 322. In some other examples, spray nozzle 410 may concentrate nutrient mist 116 within the nozzle. Spray nozzle 410 may be used with or without one or more fans, such as fan 310. Although misting apparatus 406 and 408 are depicted in a vertical orientation within spray nozzle 410 in FIG. 4, misting apparatuses may be oriented along any axis within spray nozzle 410. Additionally, in some examples, spray nozzle 410 may not fully surround misting apparatuses 406 and/or 408, but may instead be placed in such a way as to capture nutrient mist 116 as it is propelled away from misting apparatuses 406 and/or 408.

Among other benefits, a system in accordance with the disclosure may allow for plant nutrition in aeroponic growth systems. A spinning misting apparatus may be more resistant to wear and tear and may not clog due to inorganic crystallization and/or residue build-up. Additionally, a misting device in accordance with the disclosure may be relatively simple to clean and maintain as it does not encapsulate a nutrient solution or run nutrient solution through tubes or pipes which may otherwise clog. Droplet size and mist density may be adjusted and/or optimized based on the rotational speed of the misting device.

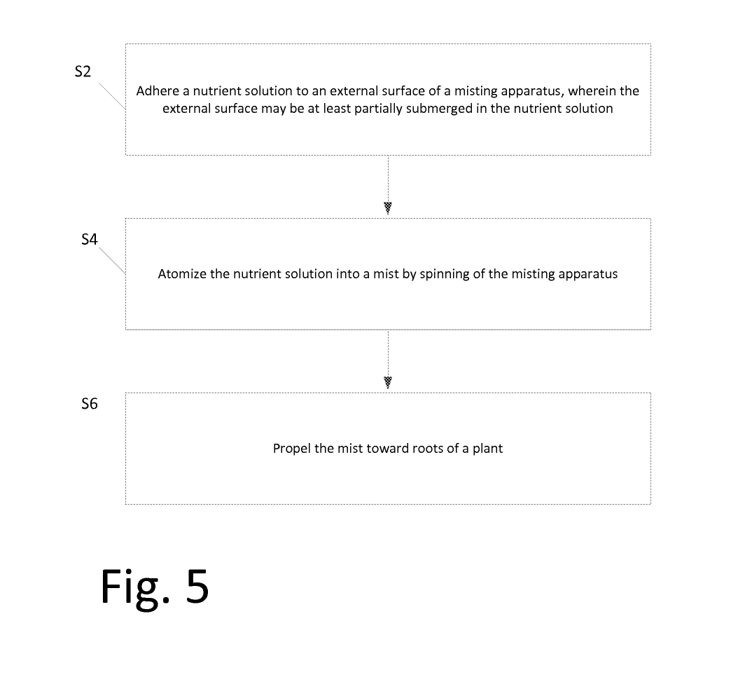

FIG. 5 depicts a flow diagram for an example process for implementing a misting device arranged in accordance with at least some embodiments described herein. In some examples, the process in FIG. 5 could be implemented using system 100 discussed above to provide nutrient mist 116 to root system 130.

An example process may include one or more operations, actions, or functions as illustrated by one or more blocks S2, S4, and/or S6. Although illustrated as discrete blocks, various blocks may be divided into additional blocks, combined into fewer blocks, or eliminated, depending on the desired implementations.

Processing may begin at block S2, “Adhere a nutrient solution to an external surface of a misting apparatus, wherein the external surface is at least partially submerged in the nutrient solution.” At block S2, a nutrient solution may be adhered to an external surface of a misting apparatus. The external surface of the misting apparatus may be at least partially submerged in the nutrient solution. The misting apparatus may be a first misting apparatus. The external surface may be a first external surface and the mist may be a first mist. The misting device may further include a second misting apparatus with a second external surface. The second misting apparatus may be effective to spin via contact with the first misting apparatus so that the nutrient solution adheres to the second external surface via contact with the first external surface. The second misting apparatus may be effective to spin via contact with the first misting apparatus so that the nutrient solution atomizes into a second mist, and so that the second mist is propelled toward roots of the plant. In some examples, the second misting apparatus may be at least partially submerged in the nutrient solution. In other examples, the second misting apparatus may not be submerged in the nutrient solution.

In some examples, the misting device may further include a processor. The processor may be effective to control the motor to spin the misting apparatus at a defined speed and/or for a defined duration. In other examples, the external surface of the misting apparatus may include a tread with features effective to cause the nutrient solution to adhere to the external surface. In other examples, the external surface of the misting apparatus may be made of a hydrophilic material.

Processing may proceed from block S2 to block S4, “Atomize the nutrient solution into a mist by spinning of the misting apparatus.” At block S4, the nutrient solution may be atomized into a mist by spinning of the misting apparatus.

Processing may proceed from block S4 to block S6, “Propel the mist toward roots of a plant.” At block S6, the mist may be propelled toward roots of a plant. In some examples, the misting device may include a fan effective to direct and/or propel the mist toward the roots. In other examples, the mist may be contained within an enclosure.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A misting device, comprising:
a nutrient solution in a basin;
a motor;
a misting apparatus connected to the motor, the misting apparatus having an external surface at least partially submerged in the nutrient solution, the motor and misting apparatus arranged such that when the motor spins the misting apparatus the nutrient solution adheres to the external surface, the nutrient solution atomizes into a mist, and so that the mist is propelled toward roots of a plant.

2. The misting device of claim 1, wherein the misting apparatus is a first misting apparatus, the external surface is a first external surface, and the mist is a first mist, the misting device further comprising:
a second misting apparatus with a second external surface, the second misting apparatus effective to:
spin via contact with the first misting apparatus so that the nutrient solution adheres to the second external surface via contact with the first external surface, atomizes into a second mist, and so that the second mist is propelled toward roots of the plant.

3. The misting device of claim 2, wherein the second misting apparatus is at least partially submerged in the nutrient solution.

4. The misting device of claim 2, wherein the second misting apparatus is not submerged in the nutrient solution.

5. The misting device of claim 1, further comprising a fan effective to direct the mist to the roots.

6. The misting device of claim 1, further comprising a processor, wherein the processor is effective to control the motor to spin the misting apparatus at a defined speed.

7. The misting device of claim 1, further comprising a processor, wherein the processor is effective to control the motor to spin the misting apparatus at a defined time for a defined duration.

8. The misting device of claim 1, further comprising a processor and a memory, wherein:
the memory is effective to store one or more instructions; and
the processor is effective to execute the one or more instructions to cause the motor to spin the misting apparatus beginning at a defined time, for a defined duration and at a defined speed.

9. The misting device of claim 1, wherein the external surface of the misting apparatus includes a tread with features effective to cause the nutrient solution to adhere to the external surface.

10. The misting device of claim 1, wherein the external surface of the misting apparatus is made of a hydrophilic material.

11. A method for providing a nutrient mist to roots of a plant, the method comprising:
adhering a nutrient solution to an external surface of a misting apparatus, wherein the external surface is at least partially submerged in the nutrient solution;
atomizing the nutrient solution into a mist by spinning of the misting apparatus; and
propelling the mist toward roots of a plant.

12. The method of claim 11, wherein the misting apparatus is a first misting apparatus, the external surface is a first external surface, and the mist is a first mist, the method further comprising:
spinning a second misting apparatus with a second external surface via contact with the first misting apparatus;
atomizing the nutrient solution into a second mist by spinning of the second misting apparatus; and
propelling the second mist toward roots of a plant.

13. The method of claim 12, wherein the second misting apparatus is at least partially submerged in the nutrient solution.

14. The method of claim 12, wherein the second misting apparatus is not submerged in the nutrient solution.

15. The method of claim 11, wherein the mist is propelled towards the roots by at least one fan.

16. The method of claim 11, wherein the external surface of the misting apparatus includes a tread with features effective to cause the nutrient solution to adhere to the external surface.

17. A misting device, comprising:
a nutrient solution in a basin;
a motor;
an enclosure;
a misting apparatus connected to the motor, the misting apparatus having an external surface at least partially submerged in the nutrient solution, the motor and misting apparatus arranged such that when the motor spins the misting apparatus the nutrient solution adheres to the external surface, the nutrient solution atomizes into a mist, and so that the mist is propelled toward roots of a plant in the enclosure; and
wherein the enclosure is effective to contain the mist.

18. The misting device of claim 17, wherein the misting apparatus is a first misting apparatus, the external surface is a first external surface, and the mist is a first mist, the misting device further comprising:
a second misting apparatus with a second external surface, the second misting apparatus effective to:
spin via contact with the first misting apparatus so that the nutrient solution adheres to the second external surface via contact with the first external surface, atomizes into a second mist, and so that the second mist is propelled toward roots of the plant in the enclosure.

19. The misting device of claim 18, wherein the second misting apparatus is at least partially submerged in the nutrient solution.

20. The misting device of claim 17, wherein the mist is propelled towards the roots in the enclosure by at least one fan.
